(19) United States
(12) Patent Application Publication
(10) Pub. No.: US 2015/0052792 A1
(43) Pub. Date: Feb. 26, 2015

(54) Notebook Labeling System

(71) Applicant: John Iovine, Staten Island, NY (US)

(72) Inventor: John Iovine, Staten Island, NY (US)

(21) Appl. No.: 13/975,777

(22) Filed: Aug. 26, 2013

(51) Int. Cl. B42B 5/12; B42D 3/00; B42F 3/06

(52) U.S. Cl. CPC B42B 5/12; B42F 3/06; B42D 3/008; B42P 2221/02
USPC 40/658; 402/3; 402/57

(57) ABSTRACT

A notebook labeling system that includes a variety of mounts to detachably attach a label to a notebook. The label includes an indicia surface that forms a visible, external display of indicia along a longitudinal axis of a notebook binder. The indicia identify and categorize the notebook. The label includes a mounting surface that utilizes an adhesive, clasps, and an elastic cord to attach the label to the notebook. The adhesive adheres to a pair of covers on the notebook for mounting the label to the notebook. The clasp pivots to a clamped position to form a tight clamp on the pair of covers or the binder. The clamp secures the label to the notebook. The elastic cord wraps around the cover to mount the label to the notebook. The label is viewable from an upright position, a flat position, or when multiple notebooks are stacked.

### FIELD OF THE INVENTION

The present invention relates generally to a notebook labeling system. More so, the notebook labeling system includes a detachable label that mounts along a longitudinal axis of a notebook binder for displaying indicia.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a label helps identify an object, such as a container or article. The label may include a piece of paper, polymer, cloth, metal, or other material affixed to the object, on which is printed indicia, information concerning the object, addresses, and the like. A label may also be printed directly on the object. Suitable materials for the label may include, without limitation, polyurethane, polyvinyl chloride, rigid polymers, flexible polymers, nonwoven materials, cardboard, paper, fiberglass, and wood.

There are many means to attach a label to an object, including, without limitation, heat activated adhesives, hot melt adhesives, pressure sensitive adhesives, clasps, elastic cords, rivets, shrink wrap, sewing, and wet glue. The labels are often detachable. In many instances, labels are pre-printed by the manufacturer. Other labels have printing applied manually or automatically at the time of application. Some labels have protective overcoats, laminates, or tape to cover them after the final print is applied. This is sometimes before application and sometimes after.

Often, a notebook is a book or binder composed of pages, often ruled, made out of paper, used for purposes including recording notes or memoranda, writing, drawing, and scrapbooking. Different types of notebooks may include a notepad, a writing pad, a drawing pad, and a legal pad.

It is well known that the information recorded in notebooks can be sensitive or private in nature. Additionally, the covers may prevent easy viewing of the information written inside the notebook. A label or indicia on the notebook that helps identify or categorize the notebook can be efficacious for a quick identification of the information inside the notebook.

Even though the above cited methods for labeling a notebook address some of the needs of the market, a notebook labeling system that detachably mounts a label to a notebook binder through a variety of means is still desired.

### SUMMARY OF THE INVENTION

The present invention is directed to a notebook labeling system that utilizes a variety of mounts to mount a detachable label to a notebook. The label forms a visible, external display that displays indicia from along a longitudinal axis of a binder. The binder, such as a spiral binder, integrates along a rear edge of the notebook, serving to retain a plurality of sheets within a pair of covers. The label utilizes various means to mount the binder. In this manner, the label is viewable when the notebook is in an upright position, a flat position, or when a plurality of notebooks is stacked on top of each other.

In one embodiment, the present invention covers a labeling system for a spiral-bound notebook. The spiral binder may include a spiral of wire looped through perforations at the top or side of the plurality of sheets inside the notebook. However, the labeling system may be employed on other types of binding mechanisms, such as, padding, sewn, clasp, and pressure bound notebooks. The labeling system mounts the binder through various mechanisms, including, without limitation, an adhesive, a clasp, and a cord. In one embodiment, the label detachably mounts the spiral binder. Those skilled in the art will recognize that indicia on the label may need to be changed to conform to evolving information and categorization. A detachable label that utilizes one of the above mentioned mounts provides flexibility to change the indicia efficiently and without tools.

In some embodiments, the label is shaped and dimensioned to position along a longitudinal axis of the binder. The label includes a mounting surface that engages the binder and a pair of covers. The pair of covers forms an outer barrier for the notebook. Additionally, the pair of covers serves to protect and help bind a plurality of sheets inside the notebook. The mounting surface attaches to the binder and the pair of covers through various means, including, without limitation, an adhesive, at least one clasp, and a pair of cords. All of the binding mechanisms engage both the binder and the pair of covers to form the attachment.

The label further includes an indicia surface that rests opposite the mounting surface. The indicia surface displays indicia, such as names, identification, text, numerals, and graphics. In this manner, the label provides a visual display of indicia that identifies and categorizes the notebook from the notebook's outer binding. The indicia may be preprinted with a subject or topic by a manufacturer. However, in another embodiment, the subject or topic may be added by a user, as needed.

The indicia may be viewed on the binder from a standing or lying position. The labeling system does not affect the pages inside the notebook, whereby pages can be removed as normal. The notebook is also able to open fully while joined with the labeling system. In conclusion, the present invention provides an external, detachable label on a notebook that is viewable when the notebook is in an upright or a flat position.

In one embodiment, the label utilizes an adhesive to mount the notebook. The adhesive is configured to adhere to a significant area of the pair of covers. The adhesive may extend along a longitudinal axis, and on opposite ends of the mounting surface. In operation, the mounting surface positions along the rear edge of the notebook, engaging the binder. The indicia surface centers along the rear edge of the notebook. The label folds over the rear edge of the notebook, extending along a planar surface of each cover. After the ends of the label are fully extended, and the indicium is centered on the binder, the mounting surface presses against the pair of covers. The adhesive then adheres the label onto the pair of covers. The label may be removed by peeling or plying off from the pair of covers.

In one embodiment, the label utilizes at least one clasp to mount the notebook. The at least one clasp serves to hold tightly together the label and the binder to prevent movement or separation through the application of inward pressure. The at least one clasp extends from the terminal ends of the label. The at least one clasp is operable to pivot from an extended position, thereby extending out from the label. The at least one clasp is further operable to pivot back to a clamped position onto the mounting surface of the label. The clamped position forms a tight grip for attaching the label to the notebook. The at least one clasp may then be pivoted back to the extended position to detach the label from the notebook

In one embodiment, the at least one clasp is configured to clamp onto the pair of covers. The at least one clasp may include two clasps on each terminal end of the label. The two clasps are located on the lateral edges of the label. In operation, the mounting surface positions along the rear edge of the notebook, engaging the binder. The indicia surface centers along the rear edge. The label folds over the rear edge of the notebook, extending along a planar surface of each cover. The two clasps are in the extended position. After the label is fully extended over the pair of covers, and the indicium is centered on the binder, the two clasps pivot to the clamped position. This forms a tight grip on the pair of covers. The label may be removed by pivoting each clasp to the extended position, thereby allowing the label to be freed from the pair of covers.

In another embodiment, the at least one clasp may utilize the binder to mount the notebook. The at least one clasp may include one centrally positioned clasp on each terminal end of the label. In operation, the mounting surface positions along the rear edge of the notebook, engaging the binder. The indicia surface centers along the rear edge. The label folds over the rear edge of the notebook, extending along a planar surface of each cover. The clasp is in the extended position. After the label is fully extended over the pair of covers, and the indicia centers on the binder, the clasp pivots to the clamped position and passes through the binder. The binder includes a tubular shaped spiral binder that enables at least partial entry of the clasp. However, any binder that has sufficient dimensions to receive the clasp may be utilized. The label may be removed by pivoting the clasp from either terminal end of the label to the extended position and pulling the label out through the free end of the binder.

In one embodiment, the label utilizes a pair of cords to mount the notebook. The pair of cords serve to encompass the pair of covers so as to mount the label to the notebook. The pair of cords attach to the label, extending along a longitudinal axis of the mounting surface and positioning on outer edges of the label. The pair of cords wrap around the planar surface of the pair of covers. In some embodiments, the pair of cords may be fabricated from an elastic material, which is configured to provide increased flexibility and detachment capacity to the label while mounted on the notebook.

In operation, mounting the label with the pair of cords require that the notebook is properly oriented for mounting. The pair of covers extends in an opposite direction from the plurality of sheets to receive the label. The label passes between the pair of covers, with the mounting surface facing the rear edge of the notebook. The label moves down between the pair of covers with the pair of cords wrapping around the outside of the covers. The label continues traversing between the pair of covers until the mounting surface engages the rear edge of the notebook. The pair of covers may then be closed down on top of the plurality of sheets. From this position, the indicia surface displays from the binder and each cord wrap around each cover. The label may be removed by pulling either cord from the cover.

In another embodiment, the label includes a pair of integrated tabs that extend from the terminal ends of the label. The pair of integrated tabs may include two tabs that extend from each terminal end of the label. The two tabs are configured to loop around the pair of covers, joining together to form a closed loop that mounts the label onto the notebook. In operation, the mounting surface positions along the rear edge of the notebook, engaging the binder. The indicia surface centers along the rear edge. The pair of integrated tabs folds forward to loop around the pair of covers and form a secure attachment with each other. In this manner, the label mounts to the notebook, working in substantially the same manner as the pair of attached cords did in the above embodiment. The label may be removed by detaching the end of the pair of tabs from each other to break the loop.

A first aspect of the present invention provides a notebook labeling system for detachably mounting indicia on a rear edge of a notebook to identify the notebook comprising:

a label, the label being configured to mount the notebook and display the indicia,

the label comprising a mounting surface, the mounting surface being configured to mount to a binder and a pair of covers, the label being disposed to align along a longitudinal axis of the binder,
the mounting surface comprising an adhesive, or at least one clasp, or a pair of cords for engaging the binder and the pair of covers, the mounting surface being configured to attach and detach from the binder and the pair of covers at least partially based on the positioning of the adhesive, or the at least one clasp, or the pair of cords,
the label further comprising an indicia surface, the indicia surface being configured to display the indicia from the rear edge of the notebook.

In a second aspect of the present invention, the label mounts to the notebook through an adhesive. The adhesive aligns along a longitudinal axis of the mounting surface to engage a significant area. The adhesive then adheres to the pair of covers to form a tight attachment between the label and the notebook. The label may be peeled off to detach from the notebook.

In another aspect, the label mounts to the notebook through at least one clasp. The at least one clasp positions on a terminal end of the label, and clamps to the binder or the pair of covers. The at least one clasp pivots to a clamped position for attaching the label to the notebook. The at least one clasp pivots to an extended position to detach the label form the notebook.

In yet another aspect, the label mounts to the notebook through a pair of cords. The pair of cords align along the longitudinal axis of the mounting surface. The pair of cords are elastic, and therefore have sufficient flexibility to wrap around the pair of covers.

In another aspect, the indicia identify and categorize the notebook. The indicia include a name, and/or an identification, and/or text, and/or a numeral, and/or a graphic.

In one objective of the present invention, the labeling system does not affect the plurality of sheets within the pair of covers, whereby the plurality of sheets can be removed with or without the label mounted to the notebook.

In another objective, the label is viewable from an upright position, a flat position, or when a plurality of notebooks is stacked on top of each other.

In another objective, the label detaches quickly, without the use of tools.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 illustrates a detailed perspective view of an exemplary notebook labeling system utilizing an adhesive to mount a label to a binder, in accordance with an embodiment of the present invention;

FIGS. 2A and 2B illustrate a top view of an exemplary label utilizing an adhesive, where FIG. 2A illustrates an indicia surface and FIG. 2B illustrates a mounting surface, in accordance with an embodiment of the present invention;

FIG. 3 illustrates an exemplary label folding over a binder and a pair of covers, in accordance with an embodiment of the present invention;

FIG. 4 illustrates a detailed perspective view of an exemplary notebook labeling system utilizing two clasps on each end of the label to mount a label to a pair of covers, in accordance with an embodiment of the present invention;

FIGS. 5A and 5B illustrate a top view of an exemplary label utilizing two clasps on each end of the label, where FIG. 5A illustrates an indicia surface and FIG. 5B illustrates a mounting surface, in accordance with an embodiment of the present invention;

FIG. 6 illustrates a detailed perspective view of an exemplary notebook labeling system utilizing one clasp on each end of the label to mount a label to a binder, in accordance with an embodiment of the present invention;

FIGS. 7A and 7B illustrate a top view of an exemplary label utilizing one clasp at each end of the label, where FIG. 7A illustrates an indicia surface and FIG. 7B illustrates a mounting surface, in accordance with an embodiment of the present invention;

FIG. 8 illustrates a detailed perspective view of an exemplary notebook labeling system utilizing a pair of cords to mount a label to a pair of covers, in accordance with an embodiment of the present invention;

FIGS. 9A and 9B illustrate a top view of an exemplary label utilizing a pair of cords, where FIG. 9A illustrates an indicia surface and FIG. 9B illustrates a mounting surface, in accordance with an embodiment of the present invention; and

FIG. 10 illustrates a detailed perspective view of an exemplary label utilizing a pair of integrated tags in an open position and a looped position, in accordance with an embodiment of the present invention.

Like reference numerals refer to like parts throughout the various views of the drawings.

### DETAILED DESCRIPTION OF THE INVENTION

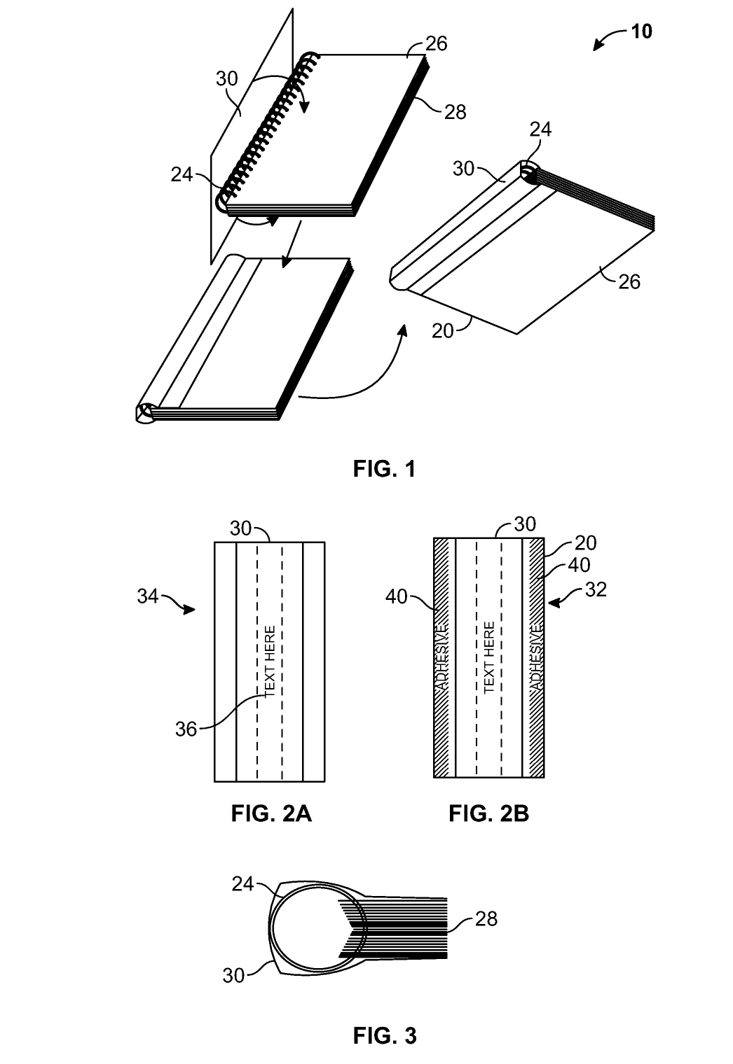

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention, a notebook labeling system 10 identifies and categorizes a notebook 20 with a detachable label that mounts along a longitudinal axis of a notebook binder 24, as referenced in FIGS. 1-10. The present invention comprises a notebook labeling system 10 that utilizes a variety of mounts to mount a label 30 to the notebook 20. The label 30 forms an external, detachable display that displays indicia 36 from along a longitudinal axis of the binder 24. The binder 24, such as a spiral binder 24, integrates along a rear edge of the notebook 20, serving to retain a plurality of sheets 28 within a pair of covers 26. The label 30 utilizes various means to mount the binder 24. In this manner, the label 30 is viewable when the notebook 20 is in an upright position, a flat position, or when a plurality of notebooks 20 is stacked on top of each other.

In one embodiment, the present invention covers a labeling system 10 for a spiral-bound notebook 20. In this manner, the notebook 20 may be labeled with a detachable label 30 that displays indicia 36 without requiring permanent integration with the notebook 20. As the functions and uses of the notebook 20 evolve, the indicia 36 may conform to the changes. Those skilled in the art will recognize that the indicia 36 may need to be changed to conform to evolving information and categorization. A detachable label 30 provides flexibility to change the indicia 36 quickly and without using tools.

In one embodiment, the labeling system 10 may be employed on other types of notebook binding mechanisms, including, without limitation, padding, sewn, clasp, and pressure bound notebooks 20. In one alternative embodiment, a binder 24 may not be utilized, but rather the label 30 mounts to a rear edge of the notebook 20, serving, at least partially as the binder 24. In one embodiment, a spiral binder may include a spiral of wire looped through perforations at the top or side of the plurality of sheets 28 inside the notebook 20. The spiral binder comprises a substantially tubular shape that is efficacious for at least partially enabling entry of various mounting mechanisms. The spiral binder is also sufficiently rigid to support the label 30. The label 30 mounts the binder 24 through various mechanisms, including, without limitation, an adhesive 40, at least one clasp 50, and a pair of cords 60. In one embodiment, the label 30 detachably mounts the binder 24 (FIGS. 1, 2A, and 2B). No tools are required to attach and detach the label from the notebook.

In some embodiments, the label 30 is shaped and dimensioned to position along a longitudinal axis of the binder 24, as referenced in FIG. 3. The label may include a substantially rectangular shape that is configured to contour the binder 24. The label may be detachable, or permanently fixed to the binder. The type of mounting mechanism is determinative of the permanence of the label on the binder. Suitable materials for the label 30 may include, without limitation, polyvinyl chloride plastic, polycarbonate, polyester plastic, flexible polymers, rigid polymers, cardboard, paper, and wood. The label may include various finishes, including, without limitation, matte, glossy, and brushed. In some embodiments, the label 30 includes a mounting surface 32 that engages the binder 24 and a pair of covers 26 that form an outer barrier for the notebook 20. The pair of covers 26 serves to protect and help bind a plurality of sheets 28 inside the notebook 20. The mounting surface 32 attaches to the binder 24 and the pair of covers 26 through various means, including, without limitation, an adhesive 40, at least one clasp 50, and a pair of cords 60. All of the binding mechanisms engage both the binder 24 and the pair of covers 26 to form the attachment.

The label 30 further includes an indicia surface 34 that rests opposite the mounting surface 32. The indicia surface 34 displays indicia 36, such as names, identification, text, numerals, and graphics. In this manner, the label 30 provides a visual display of indicia 36 that identifies and categorizes the notebook 20 from the notebook's 20 outer binder 24. The indicia 36 may be preprinted with a subject or topic by a manufacturer. However, in another embodiment, the subject or topic may be added by a user, as needed.

The indicia 36 may be viewed on the binder 24 from a standing or lying position. The label 30 positions in a substantially external area of the notebook 20. Thereby, the labeling system 10 does not affect the plurality of sheets 28 inside the notebook 20, whereby each sheet 28 can be removed without affecting the label 30. The notebook 20 is also able to open fully while joined with the notebook labeling system 10. In conclusion, the present invention provides an external, detachable label 30 on a notebook 20 that is viewable when the notebook 20 is in an upright, flat, or stacked position.

In one embodiment, the label 30 utilizes an adhesive 40 to mount the notebook 20, as referenced in FIGS. 1, 2A, and 2B. The adhesive 40 is configured to adhere to a significant area of the pair of covers 26. The adhesive 40 may extend along a longitudinal axis, and on opposite ends of the mounting surface 32. In operation, the mounting surface 32 positions along a rear edge of the notebook 20, engaging the binder 24. The indicia surface 34 centers along the rear edge of the notebook 20. The label 30 folds over the rear edge of the notebook 20, extending along a planar surface of each cover. After the ends of the label 30 are fully extended, and the indicia 36 centers on the binder 24, the mounting surface 32 presses against the pair of covers 26. The adhesive 40 then adheres the label 30 onto the pair of covers 26. The label 30 may be removed by peeling or plying off the pair of covers 26. The adhesive 40 may include, without limitation, a glue, a cement, a pressure sensitive adhesive, a heat sensitive adhesive, a one-part adhesive, a multi-part adhesive, and tape.

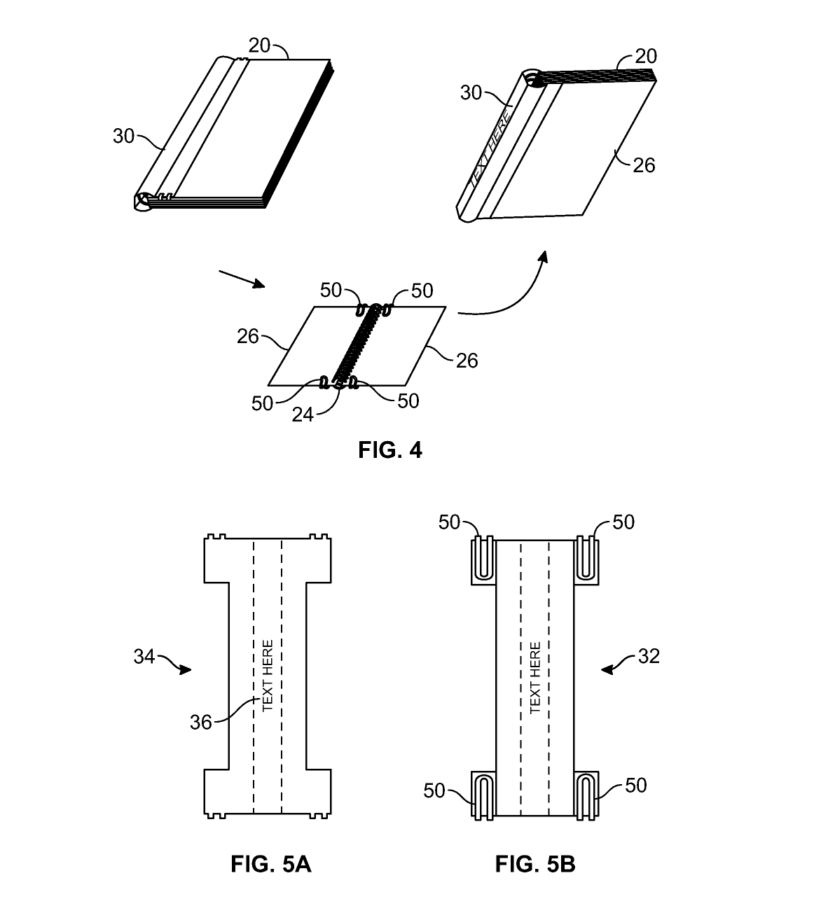

In one embodiment, the label 30 utilizes at least one clasp 50 to mount the notebook 20. The at least one clasp 50 serves to hold tightly together the label 30 and the binder 24 to prevent movement or separation through the application of inward pressure. The at least one clasp 50 extends from the terminal ends of the label 30. The at least one clasp 50 is operable to pivot from an extended position 52, thereby extending out from the label 30. The at least one clasp 50 is further operable to pivot back to a clamped position 54 onto the mounting surface 32 of the label 30. The clamped position 54 forms a tight grip for attaching the label 30 to the notebook 20. The at least one clasp 50 pivots back to the extended position 52 to detach the label 30 from the notebook 20 (FIGS. 4, 5A, and 5B).

In one embodiment, the at least one clasp 50 is configured to clamp onto the pair of covers 26. The at least one clasp 50 may include two clasps 50 on each terminal end of the label 30. The two clasps 50 are located on the lateral edges of the label 30. In operation, the mounting surface 32 positions along the rear edge of the notebook 20, engaging the binder 24. The indicia surface 34 centers along the rear edge. The label 30 folds over the rear edge of the notebook 20, extending along a planar surface of each cover 26. The two clasps 50 are in the extended position 52. After the label 30 is fully extended over the pair of covers 26, and the indicia 36 centers on the binder 24, the two clasp 50s pivot to the clamped position 54. This forms a tight grip on the pair of covers 26. The label 30 may be removed by pivoting each clasp 50 to the extended position 52, thereby allowing the label 30 to be freed from the pair of covers 26.

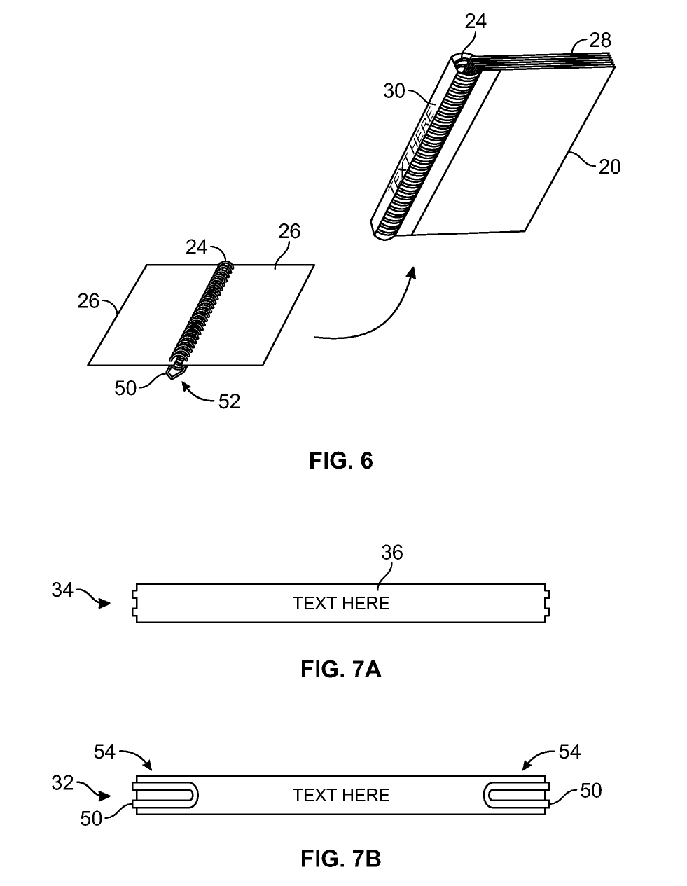

In another embodiment, the at least one clasp 50 may utilize the binder 24 to mount the notebook 20. The at least one clasp 50 may include one centrally positioned clasp 50 on each terminal end of the label 30, as referenced in FIGS. 6, 7A, and 7B. In operation, the mounting surface 32 positions along the rear edge of the notebook 20, engaging the binder 24. The indicia surface 34 centers along the rear edge. The label 30 folds over the rear edge of the notebook 20, extending along a planar surface of each cover 26. The clasp 50 is in the extended position 52. After the label 30 is fully extended over the pair of covers 26, and the indicia 36 centers on the binder 24, the clasp 50 pivots to the clamped position 54 and passes through the binder 24. In this embodiment, the binder 24 may include a tubular shaped spiral binder 24 that enables at least partial entry of the clasp 50. However, any binder 24 that has sufficient dimensions to receive the clasp 50 may be utilized. The label 30 may be removed by pivoting the clasp 50 from either terminal end of the label 30 to the extended position 52 and pulling the label 30 out through the free end of the binder 24.

In one embodiment, the label 30 utilizes a pair of cords 60 to mount the notebook 20. The pair of cords 60 serves to encompass the pair of covers 26 so as to mount the label 30 to the notebook 20. In one embodiment, the pair of cords 60 may include, without limitation, long, stringy, fibrous material, constructed of certain natural or synthetic fibers, such as elastic rubber. In some embodiments, the pair of cords 60 attach to the label 30, extending along a longitudinal axis of the mounting surface 32 and positioning on outer edges of the label 30. The pair of cords 60 wraps around the planar surface of the pair of covers 26. In some embodiments, the pair of cords 60 may be fabricated from an elastic material, which is configured to provide increased flexibility and detachment capacity to the label 30 while mounted on the notebook 20.

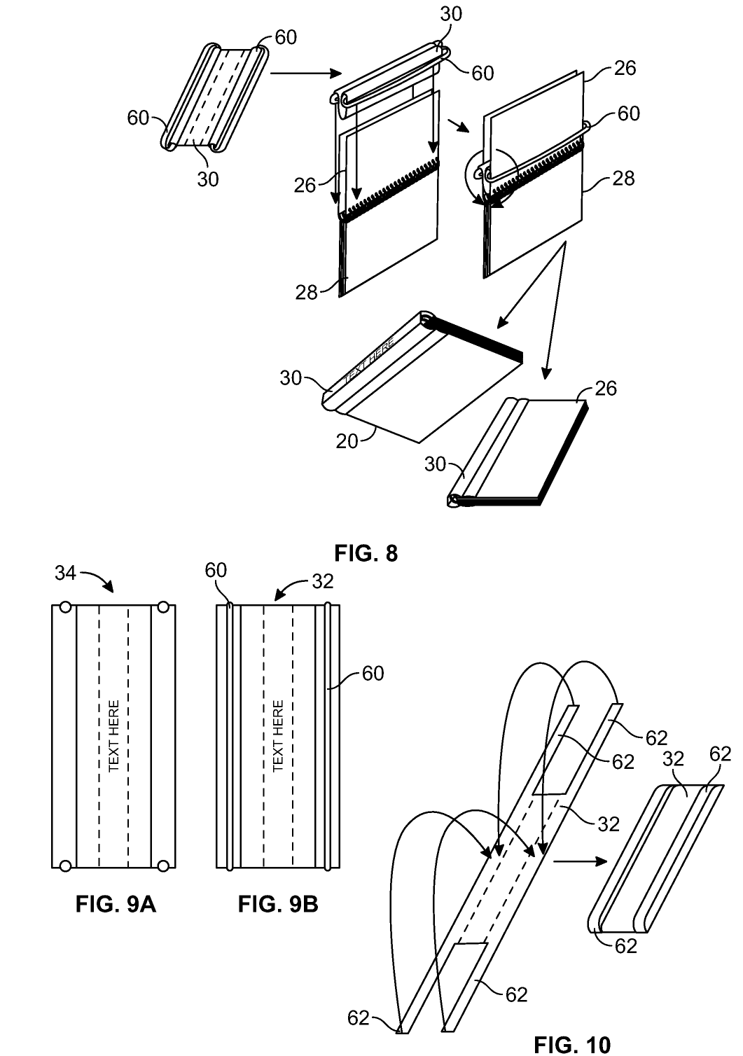

In operation, mounting the label 30 with the pair of cords 60 require that the notebook 20 is properly oriented for mounting. The pair of covers 26 extends in an opposite direction from the plurality of sheets 28 to receive the label 30. The label 30 passes between the pair of covers 26, with the mounting surface 32 facing the rear edge of the notebook 20. The label 30 moves down between the pair of covers 26 with the pair of cords 60 wrapping around the outside of the pair of covers 26. The label 30 continues traversing between the pair of covers 26 until the mounting surface 32 engages the rear edge of the notebook 20. The pair of covers 26 may then be closed down on top of the plurality of sheets 28. From this position, the indicia surface 34 displays from the binder 24 and each cord 60 wraps around each cover 26. The label 30 may be removed by pulling either cord 60 from the cover 26 (FIGS. 8, 9A, and 9B).

In another embodiment, the label 30 includes a pair of integrated tabs 62 that extend from the terminal ends of the label 30, as referenced in FIG. 10. The pair of integrated tabs 62 may include two tabs 62 that extend from each terminal end of the label 30. The two tabs 62 are configured to loop around the pair of covers 26, joining together to form a closed loop that mounts the label 30 onto the notebook 20. In operation, the mounting surface 32 positions along the rear edge of the notebook 20, engaging the binder 24. The indicia surface 34 centers along the rear edge. The pair of integrated tabs 62 folds forward to loop around the pair of covers 26 and form a secure attachment with each other. In this manner, the label 30 mounts to the notebook 20, working in substantially the same manner as the pair of attached cords 60 did in the above embodiment. The label 30 may be removed by detaching the ends of the pair of tabs 62 from each other to break the loop.

In one alternative embodiment, the notebook labeling system 10 utilizes magnets on the mounting surface 32 to mount a spiral binder. In yet another alternative embodiment, the label 30 includes a digital screen to display digital indicia, which may be controlled remotely. In yet another alternative embodiment, the mounting surface 32 and the indicia surface 34 may flip to become interchangeable. In this embodiment, each surface is functional to both mount the binder 24 and display indicia 36.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A notebook labeling system for detachably mounting indicia on a rear edge of a notebook to identify the notebook, the notebook labeling system comprising:
a label, the label being configured to mount the notebook and display the indicia,
the label comprising a mounting surface, the mounting surface being configured to mount to a binder and a pair of covers, the label being disposed to align along a longitudinal axis of the binder,
the mounting surface comprising an adhesive, or at least one clasp, or a pair of cords for engaging the binder and the pair of covers, the mounting surface being configured to attach and detach from the binder and the pair of covers at least partially based on the positioning of the adhesive, or the at least one clasp, or the pair of cords,
the label further comprising an indicia surface, the indicia surface being configured to display the indicia from the rear edge of the notebook.

2. The system of claim 1, wherein the binder comprises a spiral binder.

3. The system of claim 1, wherein the binder is disposed to position along the rear edge of the notebook.

4. The system of claim 1, wherein the binder comprises a pressure binding, or a sewn binding, or a clasped binding, or a padded binding.

5. The system of claim 1, wherein the label is disposed to orient along a longitudinal axis of the binder, the label being detachable from the binder.

6. The system of claim 1, wherein the label is disposed to orient along a longitudinal axis of the binder, the label being permanently affixed to the binder.

7. The system of claim 1, wherein the adhesive is configured to adhere to the pair of covers.

8. The system of claim 1, wherein the at least one clasp is configured to pivot to a clamped position, the clamped position being operable to attach the label to the notebook, the at least one clasp further being configured to pivot to an extended position, the extended position being configured to detach the label from the notebook.

9. The system of claim 1, wherein the at least one clasp comprises two clasps that pivot to the clamped position for attaching to the pair of covers.

10. The system of claim 1, wherein the at least one clasp comprises one clasp that at least partially passes through the binder and pivots to the clamped position for attaching to the binder.

11. The system of claim 1, wherein the pair of cords comprises elastic cords, the elastic cords comprising sufficient flexibility to wrap around the pair of covers.

12. The system of claim 1, wherein the pair of cords comprises a pair of integrated tabs, the pair of integrated tabs being disposed to extend from the label, the pair of integrated tabs being configured to loop around the pair of covers, the pair of integrated tabs further being configured to join together to form a closed loop that mounts the label to the notebook.

13. The system of claim 1, wherein the indicia comprise a name, and/or an identification, and/or text, and/or a numeral, and/or a graphic.

14. The system of claim 1, wherein the indicia comprise an indicia adhesive that affixes to the label.

15. The system of claim 1, wherein the label mounted on the notebook is configured to be viewable from an upright position, a flat position, or when a plurality of notebooks is stacked on top of each other.

16. A notebook labeling system for detachably mounting indicia on a rear edge of a notebook to identify the notebook, the notebook labeling system comprising:
a label, the label being configured to mount the notebook and display the indicia,
the label comprising a mounting surface, the mounting surface being configured to mount to a binder and a pair of covers, the label being disposed to align along a longitudinal axis of the binder,
the mounting surface comprising at least one clasp for engaging the binder and the pair of covers, the mounting surface being configured to attach and detach from the binder and the pair of covers at least partially based on the positioning of the at least one clasp,
the label further comprising an indicia surface, the indicia surface being configured to display the indicia from the rear edge of the notebook.

17. The system of claim 1, wherein the at least one clasp is configured to pivot to a clamped position, the clamped position being operable to attach the label to the notebook, the at least one clasp further being configured to pivot to an extended position, the extended position being configured to detach the label from the notebook.

18. The system of claim 17, wherein the at least one clasp comprises two clasps that pivot to the clamped position for attaching to the pair of covers.

19. The system of claim 18, wherein the at least one clasp comprises one clasp that at least partially passes through the binder and pivots to the clamped position for attaching to the binder.

20. A notebook labeling system for detachably mounting indicia on a rear edge of a notebook to identify the notebook, the notebook labeling system comprising:
a label, the label being configured to mount the notebook and display the indicia,
the label comprising a mounting surface, the mounting surface being configured to mount to a binder and a pair of covers, the label being disposed to align along a longitudinal axis of the binder,
the mounting surface comprising a pair of cords for engaging the binder and the pair of covers, the pair of cords comprising elastic cords, the elastic cords comprising sufficient flexibility to wrap around the pair of covers for mounting the label to the notebook, the mounting surface being configured to attach and detach from the binder and the pair of covers at least partially based on the positioning of the pair of cords,
the label further comprising an indicia surface, the indicia surface being configured to display the indicia from the rear edge of the notebook.
